(19) United States
(12) Patent Application Publication
(10) Pub. No.: US 2024/0282474 A1
(43) Pub. Date: Aug. 22, 2024

(54) HAZARDOUS WASTE REPOSITORY SYSTEMS

(71) Applicant: Deep Isolation, Inc., Berkeley, CA (US)

(72) Inventor: Richard A. Muller, Berkeley, CA (US)

(21) Appl. No.: 18/571,589

(22) PCT Filed: Jun. 21, 2022
(86) PCT No.: PCT/US2022/034264

§ 371 Date: Dec. 18, 2023

Related U.S. Application Data
(60) Provisional application No. 63/213,042, filed on Jun. 21, 2021.

(51) Int. Cl. G21F 9/34; E21B 41/00

(52) U.S. Cl. CPC G21F 9/34; E21B 41/005

(57) ABSTRACT

A hazardous waste repository system includes at least one vertical access drillhole formed from a terranean surface into a subterranean formation. The system further includes a first horizontal drillhole portion coupled to the vertical access drillhole and sized to receive a first hazardous waste canister. The first horizontal drillhole portion includes a first hazardous waste repository area formed at a first depth within the subterranean formation. The system further includes a second horizontal drillhole portion coupled to the at least one vertical access drillhole and sized to receive a second hazardous waste canister. The second horizontal drillhole portion includes a second hazardous waste repository area formed at a second depth within the subterranean formation such that a difference between the first and second depths is at least as much as a vertical drilling uncertainty. The second horizontal drillhole portion is horizontally spaced apart from the first horizontal drillhole portion by a distance less than a horizontal drilling uncertainty.

### TECHNICAL FIELD

This disclosure relates to hazardous waste repository systems and, more specifically, hazardous waste repository systems formed in drillholes.

### BACKGROUND

Hazardous material, such as radioactive waste, is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even high-grade military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels, and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In a general implementation, a hazardous waste repository system includes at least one vertical access drillhole formed from a terranean surface into one or more subterranean formations. The at least one vertical access drillhole includes an entry sized to receive a plurality of hazardous waste canisters that enclose hazardous waste into and through the at least one vertical access drillhole. The system further includes a first horizontal drillhole portion coupled to the at least one vertical access drillhole and sized to receive a first hazardous waste canister of the plurality of hazardous waste canisters. The first horizontal drillhole portion includes a first hazardous waste repository area formed at a first depth within a storage subterranean formation. The system further includes a second horizontal drillhole portion coupled to the at least one vertical access drillhole and sized to receive a second hazardous waste canister of the plurality of hazardous waste canisters. The second horizontal drillhole portion includes a second hazardous waste repository area formed at a second depth within the storage subterranean formation such that a difference between the first and second depths is at least as much as a vertical drilling uncertainty. The second horizontal drillhole portion is horizontally spaced apart from the first horizontal drillhole portion by a distance less than a horizontal drilling uncertainty.

An aspect combinable with the example implementation further includes a third horizontal drillhole portion coupled to the at least one vertical access drillhole and sized to receive a third hazardous waste canister of the plurality of hazardous waste canisters.

In another aspect combinable with any of the previous aspects, the third horizontal drillhole portion includes a third hazardous waste repository area formed at the first depth within the storage subterranean formation.

In another aspect combinable with any of the previous aspects, the third horizontal drillhole portion is horizontally spaced apart from the second horizontal drillhole portion by a distance less than the horizontal drilling uncertainty.

In another aspect combinable with any of the previous aspects, the third horizontal drillhole portion is horizontally spaced apart from the first horizontal drillhole portion by a distance at least as much as the horizontal drilling uncertainty.

Another aspect combinable with any of the previous aspects further includes a fourth horizontal drillhole portion coupled to the at least one vertical access drillhole and sized to receive a fourth hazardous waste canister of the plurality of hazardous waste canisters.

In another aspect combinable with any of the previous aspects, the fourth horizontal drillhole portion includes a fourth hazardous waste repository area formed at the second depth within the storage subterranean formation.

In another aspect combinable with any of the previous aspects, the fourth horizontal drillhole portion is horizontally spaced apart from the third horizontal drillhole portion by a distance less than the horizontal drilling uncertainty.

Another aspect combinable with any of the previous aspects further includes a fifth horizontal drillhole portion coupled to the at least one vertical access drillhole and sized to receive a fifth hazardous waste canister of the plurality of hazardous waste canisters.

In another aspect combinable with any of the previous aspects, the fifth horizontal drillhole portion includes a fifth hazardous waste repository area formed at a third depth within the storage subterranean formation such that a difference between the second and third depths is at least as much as the vertical drilling uncertainty.

In another aspect combinable with any of the previous aspects, the fifth horizontal drillhole portion is horizontally spaced apart from the second horizontal drillhole portion by a distance less than the horizontal drilling uncertainty.

In another aspect combinable with any of the previous aspects, the at least one vertical access drillhole includes only one vertical access drillhole.

In another aspect combinable with any of the previous aspects, the hazardous waste includes radioactive waste.

In another aspect combinable with any of the previous aspects, the radioactive waste includes spent nuclear fuel or high level waste.

In another aspect combinable with any of the previous aspects, the storage subterranean formation includes shale.

In another aspect combinable with any of the previous aspects, the vertical drilling uncertainty is 3 meters.

In another aspect combinable with any of the previous aspects, the horizontal drilling uncertainty is 10 meters.

In another aspect combinable with any of the previous aspects, the horizontal drilling uncertainty and the vertical drilling uncertainty form an uncertainty ellipsoid.

In another aspect combinable with any of the previous aspects, the second horizontal drillhole portion is stacked over the first horizontal drillhole portion, and respective uncertainty ellipses of the first and second horizontal drillhole portions are non-intersecting.

In another aspect combinable with any of the previous aspects, a vertical access drillhole coupled to the first horizontal drillhole portion is parallel to or crosses a vertical access drillhole coupled to the second horizontal drillhole portion.

In another example implementation, a method for forming a hazardous waste repository system includes forming at least one vertical access drillhole from a terranean surface into one or more subterranean formations, the at least one vertical access drillhole including an entry sized to receive a plurality of hazardous waste canisters that enclose hazardous waste into and through the at least one vertical access drillhole; forming a first horizontal drillhole portion coupled to the at least one vertical access drillhole and sized to receive a first hazardous waste canister of the plurality of hazardous waste canisters, the first horizontal drillhole portion including a first hazardous waste repository area formed at a first depth within a storage subterranean formation; and forming a second horizontal drillhole portion coupled to the at least one vertical access drillhole and sized to receive a second hazardous waste canister of the plurality of hazardous waste canisters, the second horizontal drillhole portion including a second hazardous waste repository area formed at a second depth within the storage subterranean formation such that a difference between the first and second depths is at least as much as a vertical drilling uncertainty, the second horizontal drillhole portion horizontally spaced apart from the first horizontal drillhole portion by a distance less than a horizontal drilling uncertainty.

An aspect combinable with any of the previous aspects further includes forming a third horizontal drillhole portion coupled to the at least one vertical access drillhole and sized to receive a third hazardous waste canister of the plurality of hazardous waste canisters.

In another aspect combinable with any of the previous aspects, the third horizontal drillhole portion includes a third hazardous waste repository area formed at the first depth within the storage subterranean formation.

In another aspect combinable with any of the previous aspects, the third horizontal drillhole portion is horizontally spaced apart from the second horizontal drillhole portion by a distance less than the horizontal drilling uncertainty.

In another aspect combinable with any of the previous aspects, the third horizontal drillhole portion is horizontally spaced apart from the first horizontal drillhole portion by a distance at least as much as the horizontal drilling uncertainty.

Another aspect combinable with any of the previous aspects further includes forming a fourth horizontal drillhole portion coupled to the at least one vertical access drillhole and sized to receive a fourth hazardous waste canister of the plurality of hazardous waste canisters.

In another aspect combinable with any of the previous aspects, the fourth horizontal drillhole portion includes a fourth hazardous waste repository area formed at the second depth within the storage subterranean formation.

In another aspect combinable with any of the previous aspects, the fourth horizontal drillhole portion horizontally spaced apart from the third horizontal drillhole portion by a distance less than the horizontal drilling uncertainty.

Another aspect combinable with any of the previous aspects further includes forming a fifth horizontal drillhole portion coupled to the at least one vertical access drillhole and sized to receive a fifth hazardous waste canister of the plurality of hazardous waste canisters.

In another aspect combinable with any of the previous aspects, the fifth horizontal drillhole portion includes a fifth hazardous waste repository area formed at a third depth within the storage subterranean formation such that a difference between the second and third depths is at least as much as the vertical drilling uncertainty.

In another aspect combinable with any of the previous aspects, the fifth horizontal drillhole portion is horizontally spaced apart from the second horizontal drillhole portion by a distance less than the horizontal drilling uncertainty.

In another aspect combinable with any of the previous aspects, the at least one vertical access drillhole includes only one vertical access drillhole.

In another aspect combinable with any of the previous aspects, the hazardous waste includes radioactive waste.

In another aspect combinable with any of the previous aspects, the radioactive waste includes spent nuclear fuel or high level waste.

In another aspect combinable with any of the previous aspects, the storage subterranean formation includes shale.

In another aspect combinable with any of the previous aspects, the vertical drilling uncertainty is 3 meters.

In another aspect combinable with any of the previous aspects, the horizontal drilling uncertainty is 10 meters.

In another aspect combinable with any of the previous aspects, the horizontal drilling uncertainty and the vertical drilling uncertainty form an uncertainty ellipsoid.

Another aspect combinable with any of the previous aspects further includes moving the first hazardous waste canister from the terranean surface into the first hazardous waste repository area; and moving the second hazardous waste canister from the terranean surface into the second hazardous waste repository area.

Implementations of hazardous waste repository systems and methods according to the present disclosure may also include one or more of the following features. For example, a hazardous waste repository system may be used to store hazardous waste material, such as spent nuclear fuel, isolated from human-consumable water sources. The hazardous waste repository system may be suitable for storing the hazardous waste, such as radioactive or nuclear waste, for durations of time up to, for example, 1,000,000 years. A hazardous waste repository system can store a greater volume of hazardous waste by taking advantages of drilling uncertainty to more closely pack drillholes that store the waste as compared to other drillhole repository systems. Other features are described herein.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository system that includes multiple hazardous waste repositories formed in one or more subterranean formations with directional drillholes according to the present disclosure.

FIG. 2 is a schematic side view of an example implementation of a hazardous waste repository formed in a drillhole formed in a subterranean formation that is part of a hazardous waste repository system according to the present disclosure.

FIG. 3 is a schematic illustration of a drilling uncertainty diagram according to the present disclosure.

FIG. 4A is a schematic illustration of a conventional drillhole spacing for a hazardous waste repository system that does not take advantage of drilling uncertainty relationships according to the present disclosure.

FIG. 4B is a schematic illustration of a close-packed drillhole spacing for a hazardous waste repository system that takes advantage of drilling uncertainty relationships according to the present disclosure.

### DETAILED DESCRIPTION

Hazardous waste, such as radioactive waste (e.g., spent nuclear fuel, high level waste, transuranic (TRU) waste, and other waste) can be disposed (permanently or for a certain period of time) in one or more canisters in a hazardous waste repository formed in one or more deep, directional drillholes (e.g., wellbores or boreholes). Each drillhole is formed from a terranean surface and extends through one or more subterranean formation and lands (e.g., as a horizontal drillhole) in a particular subterranean formation (e.g., shale, salt, crystalline basement rock, or other formation). The drillholes can be drilled as conventional wells, which are unoccupiable by humans (unlike conventional waste repositories that are mined).

The present disclosure describes example implementations of a hazardous waste repository system that is formed from a particular one of many example drillhole configurations. In some aspects, each drillhole configuration includes multiple horizontal or near horizontal drillholes within a limited geographic site. Such a site may be a repository for a large amount of waste, such as nuclear waste. For example, to dispose of the nuclear waste for the lifetime of a thousand megawatt commercial nuclear power plant (e.g., spent nuclear fuel), 20 km of horizontal drillhole may be needed. If such drillholes are to fit on a 1.5 km square surface site (i.e., 2.25 square km area of terranean surface), then multiple, directional drillholes may need be drilled, and the pattern of such multiple, directional drillholes must be chosen to meet, e.g., regulatory and cost requirements.

Horizontal drillhole portions can be used to dispose (or store) hazardous waste, with the horizontal portions coupled to (e.g., continuing from) vertical and curved portions of directional drillholes. In an example implementation, there can be multiple drillholes, and the disposal regions can be horizontal or nearly horizontal. Since terranean surface land available for disposal may be limited, that presents a challenge for the disposal of all the hazardous material within a given area. Further, it can be desirable that no drillhole intersects another drillhole, e.g., at any location: or if the drillholes share a common access drillhole (e.g., the vertical section that provides the depth) then it can be desirable that the horizontal drillholes not intersect in the regions in which waste is stored. Such intersections can take place during drilling because of the uncertainties in the ability to know the location of a borehole precisely and because of uncertainties in the ability to direct the drilling in a precise direction.

In some aspects, each directional drillhole includes a horizontal portion that is, e.g., between 1 and 3 km long. Conventional drilling accuracy considers a 10-meter spacing between drillhole entries at the terranean surface to be sufficient to avoid danger of intersection between drillholes beneath the terranean surface. Closer distances can be used by more careful drilling, employing measurement while drilling (MWD), and other measures. However, such procedures typically slow the drilling operation, and that increases cost since the cost of drilling is typically determined by the cost of drilling crew and rental of the drilling rig.

A hazardous waste repository that is formed from a particular one of many example drillhole configurations according to the present disclosure can take advantage of two concepts. First, the suitable disposal rock formation (e.g., the formation in which the waste is stored in the horizontal portion of the drillhole) is often thick enough to allow horizontal drilling at different depths. Second, in the drilling industry, uncertainty in vertical depth (e.g., in the location of the drill bit in a vertical direction) is typically less than uncertainty in horizontal location (e.g., in the location of the drill bit in a horizontal direction). This uncertainly asymmetry is a consequence of the fact that gravity helps determine the vertical orientation of the drillhole, but does not aid in determining the horizontal orientation.

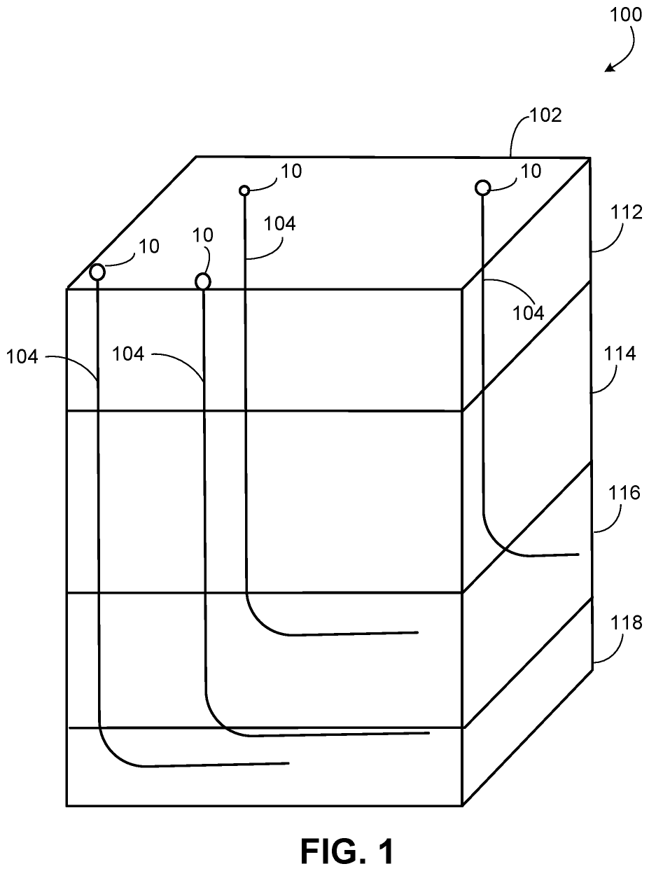

FIG. 1 is a schematic illustration of an example implementation of a hazardous waste repository system 100. As shown, system 100 includes one or more hazardous waste repository drillholes 104 that are formed from a terranean surface 102 to one or more subterranean formations 116, 118 (and others) located below the terranean surface 102. In some aspects, each drillhole 104 comprises a directional drillhole with an entry 10 (e.g., sized to receive one or more hazardous waste canisters that enclose hazardous waste), vertical portion, a curved portion (e.g., radius portion), and a horizontal portion. In some aspects, multiple curved and horizontal portions may extend from a single vertical portion. Or, as shown, each drillhole 104 may have its own vertical, curved, and horizontal portion. In some aspects, each drillhole 104 comprises a wellbore or borehole, i.e., a human-unoccupiable borehole. In some aspects, one or more drillholes 104 may have previously produced hydrocarbons or water (or both) from the one or more subterranean formations 112, 114, 116, or 118 to the terranean surface 102.

In alternative implementations, each drillhole 104 can include horizontal, vertical (e.g., only vertical), slant, curved, and other types of borehole geometries and orientations. One or more drillholes 104 may be uncased or include uncased sections, such as a horizontal portion that may be fully or partially an open hole completion. Although illustrated as generally vertical portions and generally horizontal portions, such parts of the drillholes 104 may deviate from exactly vertical and exactly horizontal (e.g., relative to the terranean surface 102) depending on the formation techniques of the particular drillhole 104, type of rock formation in the subterranean formations 112, 114, 116, 118, and other factors. Generally, the present disclosure contemplates all conventional and novel techniques for forming the drillhole 104 from the surface 102 into the subterranean formations 104a-104c.

Although three drillholes 104 are shown in FIG. 1, system 100 may include more or fewer drillholes 104 and, in some aspects, many more drillholes 104. Further, although labeled as a terranean surface 102, this surface may be any appropriate surface on Earth (or other planet) from which the hazardous waste repository system 100 may be formed. For example, in some aspects, the surface 102 may represent a body of water, such as a sea, gulf, ocean, lake, or otherwise. Each drillhole 104, as discussed herein, can be or be part of a hazardous waste repository that stores hazardous waste (e.g., chemical waste, biological waste, radioactive waste such as spent nuclear fuel or other waste) in a subterranean formation for a predetermined or indeterminate period of time.

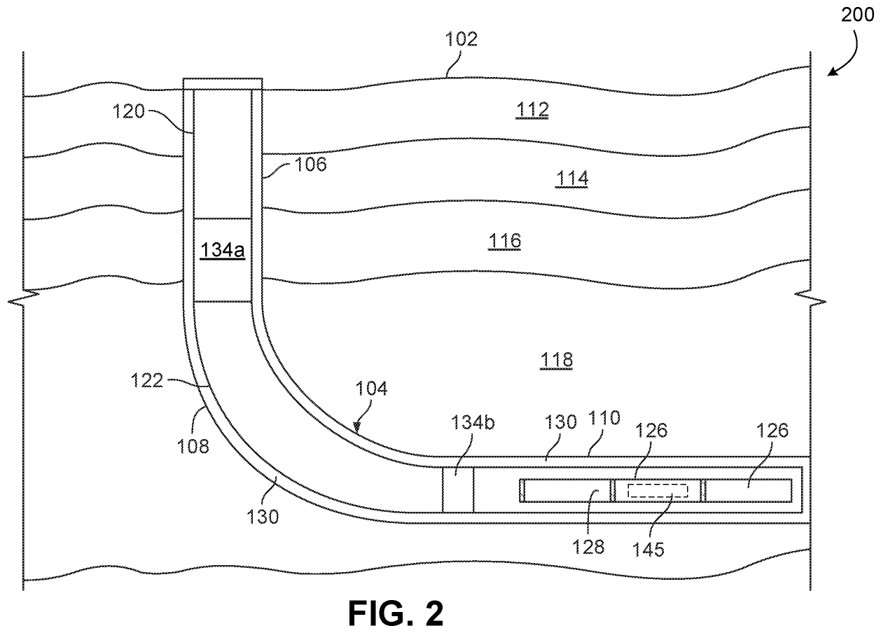

FIG. 2 is a schematic illustration of an example implementation of a hazardous waste repository 200 formed in a particular drillhole 104 (also referred to as a hazardous waste repository), e.g., a subterranean location for the long-term (e.g., tens, hundreds, or thousands of years or more), but retrievable, safe and secure storage of hazardous material (e.g., radioactive material, such as nuclear waste which can be spent nuclear fuel (SNF) or high level waste, as two examples). For example, this figure illustrates the example hazardous waste repository 200 once one or more canisters 126 of hazardous material have been deployed in a subterranean formation 118. As illustrated, the hazardous waste repository 200 includes or is formed in a particular drillhole 104 (with such repository 200 formed in each drillhole 104 as part of hazardous waste repository system 100). The drillhole 104 is formed (e.g., drilled or otherwise) from terranean surface 102 and through multiple subterranean layers 112, 114, 116, and 118. As noted, the terranean surface 102 is illustrated as a land surface, terranean surface 102 may be a sub-sea or other underwater surface, such as a lake or an ocean floor or other surface under a body of water. Thus, the present disclosure contemplates that the drillhole 104 may be formed under a body of water from a drilling location on or proximate the body of water.

The illustrated drillhole 104 is a directional drillhole in this example of hazardous waste repository 200. For instance, the drillhole 104 includes a substantially vertical portion 106 coupled to a radiused or curved portion 108, which in turn is coupled to a substantially horizontal portion 110. As used in the present disclosure, “substantially” in the context of a drillhole orientation, refers to drillholes that may not be exactly vertical (e.g., exactly perpendicular to the terranean surface 102) or exactly horizontal (e.g., exactly parallel to the terranean surface 102), or exactly vertical at a particular incline angle relative to the terranean surface 102. In other words, vertical drillholes often undulate offset from a true vertical direction, and they might be drilled at an angle that deviates from true vertical. Instead, the incline of the drillhole may vary over its length (e.g., by 1-5 degrees). As illustrated in this example, the three portions of the drillhole 104—the vertical portion 106, the radiused portion 108, and the horizontal portion 110—form a continuous drillhole 104 that extends into the Earth. As used in the present disclosure, the drillhole 104 (and drillhole portions described) may also be called wellbores. Thus, as used in the present disclosure, drillhole and wellbore are largely synonymous and refer to bores formed through one or more subterranean formations that are not suitable for human-occupancy (i.e., are too small in diameter for a human to fit there within).

The illustrated drillhole 104, in this example, has a surface casing 120 positioned and set around the drillhole 104 from the terranean surface 102 into a particular depth in the Earth. For example, the surface casing 120 may be a relatively large-diameter tubular member (or string of members) set (e.g., cemented) around the drillhole 104 in a shallow formation. As used herein, “tubular” may refer to a member that has a circular cross-section, elliptical cross-section, or other shaped cross-section. For example, in this implementation of the hazardous waste repository 200, the surface casing 120 extends from the terranean surface through a surface layer 112. The surface layer 112, in this example, is a geologic layer comprised of one or more layered rock formations. In some aspects, the surface layer 112 in this example may or may not include freshwater aquifers, salt water or brine sources, or other sources of mobile water (e.g., water that moves through a geologic formation). In some aspects, the surface casing 120 may isolate the drillhole 104 from such mobile water, and may also provide a hanging location for other casing strings to be installed in the drillhole 104. Further, although not shown, a conductor casing may be set above the surface casing 120 (e.g., between the surface casing 120 and the surface 102 and within the surface layer 112) to prevent drilling fluids from escaping into the surface layer 112.

As illustrated, a production casing 122 is positioned and set within the drillhole 104 downhole of the surface casing 120. Although termed a “production” casing, in this example, the casing 122 may or may not have been subject to hydrocarbon production operations. Thus, the casing 122 refers to and includes any form of tubular member that is set (e.g., cemented) in the drillhole 104 downhole of the surface casing 120. In some examples of the hazardous waste repository 200, the production casing 122 may begin at an end of the radiused portion 108 and extend throughout the horizontal portion 110. The casing 122 could also extend into the radiused portion 108 and into the vertical portion 106.

As shown, cement 130 is positioned (e.g., pumped) around the casings 120 and 122 in an annulus between the casings 120 and 122 and the drillhole 104. The cement 130, for example, may secure the casings 120 and 122 (and any other casings or liners of the drillhole 104) through the subterranean layers under the terranean surface 102. In some aspects, the cement 130 may be installed along the entire length of the casings (e.g., casings 120 and 122 and any other casings), or the cement 130 could be used along certain portions of the casings if adequate for a particular drillhole 104. The cement 130 can also provide an additional layer of confinement for the hazardous material in canisters 126.

The drillhole 104 and associated casings 120 and 122 may be formed with various example dimensions and at various example depths (e.g., true vertical depth, or TVD). For instance, a conductor casing (not shown) may extend down to about 120 feet TVD, with a diameter of between about 28 in. and 60 in. The surface casing 120 may extend down to about 2500 feet TVD, with a diameter of between about 22 in. and 48 in. An intermediate casing (not shown) between the surface casing 120 and production casing 122 may extend down to about 8000 feet TVD, with a diameter of between about 16 in. and 36 in. The production casing 122 may extend inclinedly (e.g., to case the horizontal portion 110) with a diameter of between about 11 in. and 22 in. The foregoing dimensions are merely provided as examples and other dimensions (e.g., diameters, TVDs, lengths) are contemplated by the present disclosure. For example, diameters and TVDs may depend on the particular geological composition of one or more of the multiple subterranean layers (112, 114, 116, and 118), particular drilling techniques, as well as a size, shape, or design of a hazardous material canister 126 that contains hazardous material to be deposited in the hazardous waste repository 200. In some alternative examples, the production casing 122 (or other casing in the drillhole 104) could be circular in cross-section, elliptical in cross-section, or some other shape.

As illustrated, the vertical portion 106 of the drillhole 104 extends through subterranean layers 112, 114, and 116, and, in this example, lands in a subterranean layer 118. As discussed above, the surface layer 112 may or may not include mobile water. In this example, a mobile water layer 114 is below the surface layer 112 (although surface layer 112 may also include one or more sources of mobile water or liquid). For instance, mobile water layer 114 may include one or more sources of mobile water, such as freshwater aquifers, salt water or brine, or other source of mobile water. In this example of hazardous waste repository 200, mobile water may be water that moves through a subterranean layer based on a pressure differential across all or a part of the subterranean layer. For example, the mobile water layer 114 may be a permeable geologic formation in which water freely moves (e.g., due to pressure differences or otherwise) within the layer 114. In some aspects, the mobile water layer 114 may be a primary source of human-consumable water in a particular geographic area. Examples of rock formations of which the mobile water layer 114 may be composed include porous sandstones and limestones, among other formations.

Other illustrated layers, such as the impermeable layer 116 and the storage layer 118, may include immobile water. Immobile water, in some aspects, is water (e.g., fresh, salt, brine), that is not fit for human or animal consumption, or both. Immobile water, in some aspects, may be water that, by its motion through the layers 116 or 118 (or both), cannot reach the mobile water layer 114, terranean surface 102, or both, within 10,000 years or more (such as to 1,000,000 years).

Below the mobile water layer 114, in this example implementation of hazardous waste repository 200, is an impermeable layer 116. The impermeable layer 116, in this example, may not allow mobile water to pass through. Thus, relative to the mobile water layer 114, the impermeable layer 116 may have low permeability, e.g., on the order of nanodarcy permeability. Additionally, in this example, the impermeable layer 116 may be a relatively non-ductile (i.e., brittle) geologic formation. One measure of non-ductility is brittleness, which is the ratio of compressive stress to tensile strength. In some examples, the brittleness of the impermeable layer 116 may be between about 20 MPa and 40 MPa.

As shown in this example, the impermeable layer 116 is shallower (e.g., closer to the terranean surface 102) than the storage layer 118. In this example, rock formations of which the impermeable layer 116 may be composed include, for example, certain kinds of sandstone, mudstone, clay, and slate that exhibit permeability and brittleness properties as described above. In alternative examples, the impermeable layer 116 may be deeper (e.g., further from the terranean surface 102) than the storage layer 118. In such alternative examples, the impermeable layer 116 may be composed of an igneous rock, such as granite.

Below the impermeable layer 116 is the storage layer 118. The storage layer 118, in this example, may be chosen as the landing for the horizontal portion 110, which stores the hazardous material, for several reasons. Relative to the impermeable layer 116 or other layers, the storage layer 118 may be thick, e.g., between about 100 and 200 feet of total vertical thickness. Thickness of the storage layer 118 may allow for easier landing and directional drilling, thereby allowing the horizontal portion 110 to be readily emplaced within the storage layer 118 during constructions (e.g., drilling). If formed through an approximate horizontal center of the storage layer 118, the horizontal portion 110 may be surrounded by about 50 to 100 feet of the geologic formation that comprises the storage layer 118. Further, the storage layer 118 may also have only immobile water, e.g., due to a very low permeability of the layer 118 (e.g., on the order of milli- or nanodarcys). In addition, the storage layer 118 may have sufficient ductility, such that a brittleness of the rock formation that comprises the layer 118 is between about 3 MPa and 10 MPa. Examples of rock formations of which the storage layer 118 may be composed include shale, salt, and anhydrite (among others). Further, in some aspects, hazardous material may be stored below the storage layer, even in a permeable formation such as sandstone or limestone, if the storage layer is of sufficient geologic properties to isolate the permeable layer from the mobile water layer 114.

In some aspects, the layer 118 may have properties suitable for a long-term confinement of nuclear waste, and for its isolation from a mobile water layer (e.g., aquifers) and a terranean surface. Such formations may be found relatively deep in the Earth, typically 3000 feet or greater, and placed in isolation below any fresh water aquifers. For instance, the appropriate formation may include geologic properties that enhance the long-term (e.g., thousands of years) isolation of material. Such properties, for instance, have been illustrated through the long term storage (e.g., tens of millions of years) of hydrocarbon fluids (e.g., gas, liquid, mixed phase fluid) without escape of substantial fractions of such fluids into surrounding layers (e.g., mobile water layer).

For example, shale has been shown to hold natural gas for millions of years or more, giving it a proven capability for long-term storage of hazardous material. Example shale formations (e.g., Marcellus, Eagle Ford, Barnett, and otherwise) has stratification that contains many redundant sealing layers that have been effective in preventing movement of water, oil, and gas for millions of years, lacks mobile water, and can be expected (e.g., based on geological considerations) to seal hazardous material (e.g., fluids or solids) for thousands of years after deposit. In some aspects, the formation may form a leakage barrier, or barrier layer to fluid leakage that may be determined, at least in part, by the evidence of the storage capacity of the layer for hydrocarbons or other fluids (e.g., carbon dioxide) for hundreds of years, thousands of years, tens of thousands of years, hundreds of thousands of years, or even millions of years.

Another particular quality of shale that may advantageously lend itself to hazardous material storage is its clay content, which, in some aspects, provides a measure of ductility greater than that found in other, impermeable rock formations. For example, shale may be stratified, made up of thinly alternating layers of clays (e.g., between about 20-30% clay by volume) and other minerals. Such a composition may make shale less brittle and, thus less susceptible to fracturing (e.g., naturally or otherwise) as compared to rock formations in the impermeable layer (e.g., dolomite or otherwise). For example, rock formations in the impermeable layer may have suitable permeability for the long term storage of hazardous material, but are too brittle and commonly are fractured. Thus, such formations may not have sufficient sealing qualities (as evidenced through their geologic properties) for the long term storage of hazardous material.

In some aspects, the formation of the storage layer 118 and/or the impermeable layer 116 may form a leakage barrier, or barrier layer to fluid leakage that may be determined, at least in part, by the evidence of the storage capacity of the layer for hydrocarbons or other fluids (e.g., carbon dioxide) for hundreds of years, thousands of years, tens of thousands of years, hundreds of thousands of years, or even millions of years. For example, the barrier layer of the storage layer 118 and/or impermeable layer 116 may be defined by a time constant for leakage of the hazardous material more than 10,000 years (such as between about 10,000 years and 1,000,000 years) based on such evidence of hydrocarbon or other fluid storage.

The present disclosure contemplates that there may be many other layers between or among the illustrated subterranean layers 112, 114, 116, and 118. For example, there may be repeating patterns (e.g., vertically), of one or more of the mobile water layer 114, impermeable layer 116, and storage layer 118. Further, in some instances, the storage layer 118 may be directly adjacent (e.g., vertically) the mobile water layer 114, i.e., without an intervening impermeable layer 116. In some examples, all or portions of the radiused portion 108 and the horizontal portion 110 may be formed below the storage layer 118, such that the storage layer 118 (e.g., shale or other geologic formation with characteristics as described herein) is vertically positioned between the horizontal drillhole 110 and the mobile water layer 114.

In this example, the horizontal portion 110 of the drillhole 104 includes a storage area in a distal part of the portion 110 into which hazardous material may be retrievably placed for long-term storage. For example, a work string (e.g., tubing, coiled tubing, wireline, or otherwise) or other downhole conveyance (e.g., tractor) may be moved into the cased drillhole 104 to place one or more (three shown but there may be more or less) hazardous material canisters 126 into long term, but in some aspects, retrievable, storage in the portion 110.

Each canister 126 may enclose hazardous material (shown as material 145). Such hazardous material, in some examples, may be biological or chemical waste or other biological or chemical hazardous material. In some examples, the hazardous material may include nuclear material, such as SNF recovered from a nuclear reactor (e.g., commercial power or test reactor) or military nuclear material. Spent nuclear fuel, in the form of nuclear fuel pellets, may be taken from the reactor and not modified. Nuclear fuel pellet are solid, although they can contain and emit a variety of radioactive gases including tritium (13 year half-life), krypton-85 (10.8 year half-life), and carbon dioxide containing C-14 (5730 year half-life). Other hazardous material 145 may include, for example, radioactive liquid, such as radioactive water from a commercial power (or other) reactor.

In some aspects, the storage layer 118 should be able to contain any radioactive output (e.g., gases) within the layer 118, even if such output escapes the canisters 126. For example, the storage layer 118 may be selected based on diffusion times of radioactive output through the layer 118. For example, a minimum diffusion time of radioactive output escaping the storage layer 118 may be set at, for example, fifty times a half-life for any particular component of the nuclear fuel pellets. Fifty half-lives as a minimum diffusion time would reduce an amount of radioactive output by a factor of 1×10⁻¹⁵. As another example, setting a minimum diffusion time to thirty half-lives would reduce an amount of radioactive output by a factor of one billion.

For example, plutonium-239 is often considered a dangerous waste product in SNF because of its long half-life of 24,100 years. For this isotope, 50 half-lives would be 1.2 million years. Plutonium-239 has low solubility in water, is not volatile, and as a solid. its diffusion time is exceedingly small (e.g., many millions of years) through a matrix of the rock formation that comprises the illustrated storage layer 118 (e.g., shale or other formation). The storage layer 118, for example comprised of shale, may offer the capability to have such isolation times (e.g., millions of years) as shown by the geological history of containing gaseous hydrocarbons (e.g., methane and otherwise) for several million years. In contrast, in conventional nuclear material storage methods, there was a danger that some plutonium might dissolve in a layer that comprised mobile ground water upon confinement escape.

In some aspects, the drillhole 104 may be formed for the primary purpose of long-term storage of hazardous materials. In alternative aspects, the drillhole 104 may have been previously formed for the primary purpose of hydrocarbon production (e.g., oil, gas). For example, storage layer 118 may be a hydrocarbon bearing formation from which hydrocarbons were produced into the drillhole 104 and to the terranean surface 102. In some aspects, the storage layer 118 may have been hydraulically fractured prior to hydrocarbon production. Further, in some aspects, the production casing 122 may have been perforated prior to hydraulic fracturing. In such aspects, the production casing 122 may be patched (e.g., cemented) to repair any holes made from the perforating process prior to a deposit operation of hazardous material. In addition, any cracks or openings in the cement between the casing and the drillhole can also be filled at that time.

As shown in this example, a drillhole seal 134a, such as a plug, packer, or other seal, is positioned in the vertical portion 106 of the directional drillhole 104. In some aspects, the drillhole seal 134a may prevent or help prevent hazardous waste stored in the canisters 126, or solids or fluids released by the hazardous waste in the canisters 126, from moving through the vertical portion 106 toward the terranean surface 102 from the horizontal portion 110. As further shown in this example implementation, the drillhole seal 134a is placed in the vertical drillhole portion 106, while the drillhole seal 134b is placed in the horizontal drillhole portion 110. Although two drillhole seals 134a and 134b are shown, more or fewer drillhole seals according to the present disclosure may be positioned in the hazardous waste repository 200. Further, in some aspects, both drillhole seals 134a and 134b (and others is applicable) may be positioned in the vertical drillhole portion 106. Alternatively, both drillhole seals 134a and 134b (and others is applicable) may be positioned in the horizontal drillhole portion 110. In some aspects, one or more drillhole seals (such as 134a or 134b) may be positioned in the transition drillhole portion 108. In some aspects, two or more drillhole seals (such as 134a and 134b) may be positioned in contact with each other in the directional drillhole 104.

In some aspects, one or more of the previously described components of the repository 200 may combine to form an engineered barrier of the hazardous waste material repository 200. For example, in some aspects, the engineered barrier is comprised of one, some, or all of the following components: the storage layer 118, the casing 120, the backfill material 140, the canister 126, the backfill material 150, the seal 134, and the hazardous material 145, itself. In some aspects, one or more of the engineered barrier components may act (or be engineered to act) to: prevent or reduce corrosion in the drillhole 104, prevent or reduce escape of the hazardous material 145; reduce or prevent thermal degradation of one or more of the other components; and other safety measures to ensure that the hazardous material 145 does not reach the mobile water layer 114 (or surface layer 112, including the terranean surface 102).

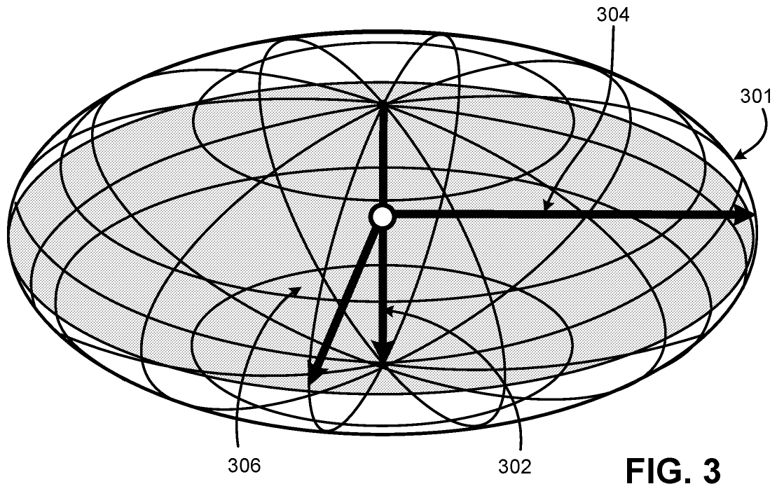

FIG. 3 shows a drilling uncertainty diagram 300. When forming drillhole 104 (or multiple drillholes 104 for hazardous waste repository system 100) through drilling techniques, drilling uncertainties can affect the location or position of each drillhole 104 relative to other drillholes 104 in the system 100. More specifically, FIG. 3 shows an uncertainty ellipsoid 301 for directional drilling and shows an asymmetry between vertical uncertainty 302 and horizontal uncertainties 304 and 306. The uncertainty ellipsoid 301 shows that the vertical uncertainty 302 is smaller than the two horizontal uncertainties 304 and 306. One horizontal uncertainty 306 is the “Semi-Minor” uncertainty driven by inclination errors in the drilling process. Another horizontal uncertainty 304 is the “Semi-Major” uncertainty driven by azimuth errors in the drilling process, and this uncertainty 304 is greater (typically) than the Semi-Minor uncertainty 306.

Because of the reduced uncertainty 302 in vertical depth, two drillholes 104 can be drilled close to each other horizontally (in plan view) if their depths differ by the reduced vertical uncertainty 302. In an example horizontal layout, the spacing can be considered safe (e.g., with reduced chance to intersect another drillhole below the surface) if the horizontal spacing between drillholes at the surface is at least 10 meters. Consistent with FIG. 3, the corresponding vertical spacing for safe separation can be 3 meters. Then the horizontal separation distance can be small, as long as the vertical separation is 3 meters. An intermediate diagonal separation could also be used, as long as the separation falls outside of the uncertainty eclipse.

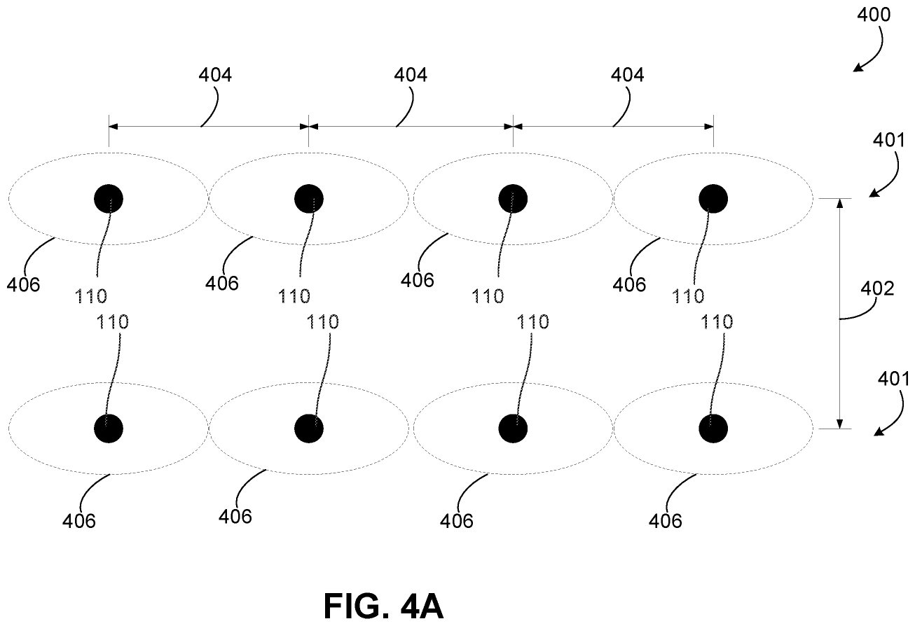

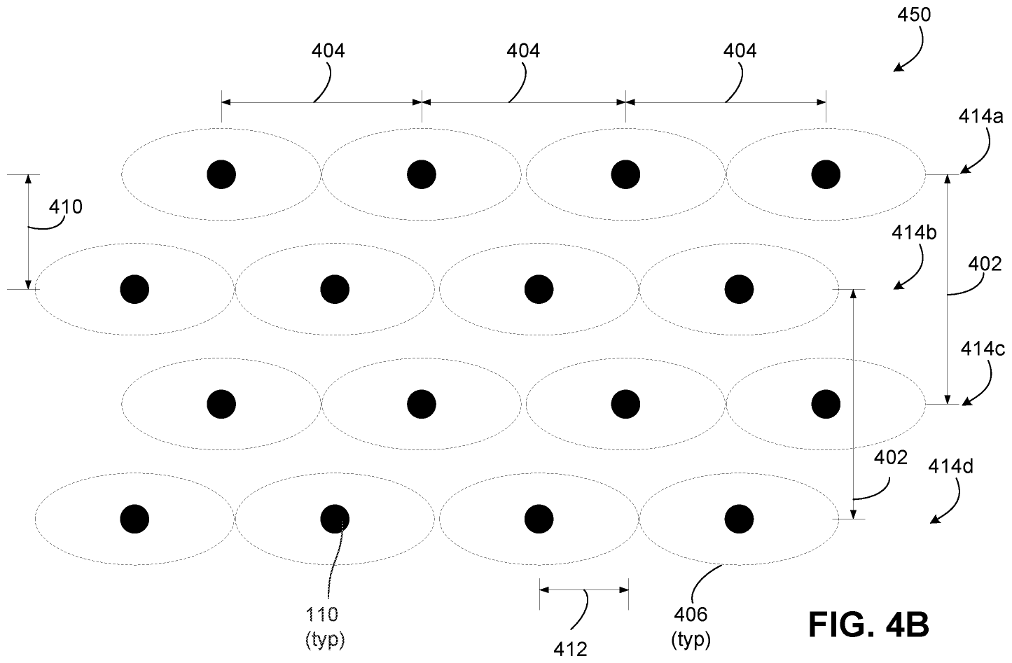

FIGS. 4A-4B show example drillhole configurations for hazardous waste repository system 100 (using multiple hazardous waste repositories 200) that follow from the uncertainties introduced in FIG. 3. FIGS. 4A-4B both show a drillhole configuration seen end-on (i.e., in a gun barrel view) into the horizontal portions 110 of the drillholes 104.

As shown in FIG. 4A, a drillhole configuration 400 shows a conventional drillhole spacing that does not take advantage of the uncertainty relationships explained with reference to FIG. 3. In this figure, the drillhole configuration 400 includes multiple drillholes with horizontal portions 110 formed within rows 401 (where the radial centerlines of horizontal portions 110 within the same row are considered to be at or approximately at a same true vertical depth). Each horizontal portion 110 has an associated uncertainty ellipse 406 that defines an area there within in which further drilling may, e.g., cause interaction or a “hit” between two drillhole. As shown in this figure, a radial centerline of each horizontal portion 110 is or must be separated by a minimum horizontal distance 404 and a minimum vertical distance 402 from each other horizontal portion 110. In some aspects, minimum horizontal distance 404 may be about 10 meters, while minimum vertical distance 402 may be about 5 meters due to established drilling uncertainties (e.g., the vertical uncertainty 302 and semi-major horizontal uncertainty 304 shown in FIG. 3).

FIG. 4B shows a drillhole configuration 450 that is a close-packed uncertainty ellipse spacing of drillholes 104 that takes advantage of the uncertainty relationships explained with reference to FIG. 3. In this example, the close-packed uncertainty ellipse spacing of drillholes 104 (with horizontal portions 110 shown) can provide about three-times a disposal density (e.g., in units of waste per square kilometer projected on the surface) as compared to the configuration in FIG. 4A while requiring only 5 meters of vertical depth between horizontal portions 110. Although uncertainty ellipses 406 are shown “apart” in FIGS. 4A and 4B, they can be directly adjacent, e.g., with no space between them, but without intersecting.

For example, as shown in FIG. 4B, drillhole configuration 450 has multiple drillholes with horizontal portions 110 formed within alternatingly offset rows 414a-414d as shown (where the radial centerlines of horizontal portions 110 within rows 414a-414d are considered to be at or approximately at a same true vertical depth). In this example, rows 414a and 414c are offset from rows 414b and 414d in that radial centerlines of horizontal portions 110 in rows 414a and 414c are horizontally aligned (exactly or substantially), and horizontally misaligned (exactly or substantially) with radial centerlines of horizontal portions 110 in rows 414b and 414d. Rows 414b and 414d are offset from rows 414a and 414c in that radial centerlines of horizontal portions 110 in rows 414b and 414d are horizontally aligned (exactly or substantially), and horizontally misaligned (exactly or substantially) with radial centerlines of horizontal portions 110 in rows 414a and 414c.

Each horizontal portion 110 has an associated uncertainty ellipse 406 that defines an area therewithin in which further drilling may, e.g., cause interaction or a “hit” between two drillhole. As shown in this figure, a radial centerline of each horizontal portion 110 of drillholes within a particular row (414a, 414b, 414c, or 414d) are still separated by a minimum horizontal distance 404. A radial centerline of each horizontal portion 110 of drillholes within a particular row (414a, 414b, 414c, or 414d) are still separated by a minimum vertical distance 402 from each other horizontal portion 110 in a horizontally aligned row (i.e., row 414a is separated by distance 410 from row 414c, while row 414b is separated by distance 410 from row 414d). In some aspects, minimum horizontal distance 404 may be about 10 meters, while minimum vertical distance 402 may be about 5 meters due to established drilling uncertainties (e.g., the vertical uncertainty 302 and semi-major horizontal uncertainty 304 shown in FIG. 3).

As shown however, drillhole portions 110 in adjacent rows (with row 414a adjacent to row 414b, and row 414b adjacent to row 414c, and row 414c adjacent to row 414d, etc.) can have radial centerlines separated by distances less than minimum horizontal distance 404 and minimum vertical distance 402. For example, as shown, while still keeping uncertainty principles of FIG. 3 in mind (e.g., with no uncertainty ellipse 406 of a particular horizontal portion 110 of a particular drillhole 104 intersecting with another uncertainty ellipse 406 of any other horizontal portion 110 of any other drillhole 104), horizontal portions 110 in row 414a can be vertically separated from horizontal portions 110 in row 414b by vertical distance 410 (which is less than vertical distance 402). Further, horizontal portions 110 in row 414a can be horizontally separated from horizontal portions 110 in row 414b by horizontal distance 412 (which is less than vertical distance 402).

Drillhole configuration 450 shown in FIG. 4B can be called a “close packed uncertainty ellipse spacing” since the horizontal distance between drillholes is determined by the size of the uncertainty ellipses. For example, in just 5 meters of vertical usage, this configuration can triple the density of disposal (in waste per square kilometer). As a result, an amount of waste that is expected to reach the terranean surface, e.g., in 1 million years, can have triple the density although the waste would be spread over one third of the terranean surface area compared to conventional spacing. But simulations of safety indicate that this increase will often not be enough to render the site unsafe.

As another concern, local heating (e.g., without the drillholes and within the storage formation) would be increased, for example, if spent nuclear fuel or some other high heat source material is the waste. This is due to thermal interaction of the closely spaced drillholes. For any specific application, that increase can be calculated to determine to ensure continued safe storage. In simulations of safety, the spacing as shown in FIG. 4B, is adequate to avoid any overheating problem.

There are many configurations that achieve close packed uncertainty ellipse spacing: FIG. 4B shows only one. The close-packed spacing shown in FIG. 4B is not the only example configuration that can take advantage of the shape of the uncertainty ellipse 406. For example, a set of drillholes could be formed to be directly on top of each other, e.g., in different vertical depths but “stacked” in a gun barrel view of the drillhole, or crossing each other, as long as the uncertainty ellipses 406 do not intersect.

In some aspects, each individual directional drillhole horizontal portion 110 can extend from individual vertical drillhole portions 106 (i.e., access holes). In another example configuration, more than one directional drillhole horizontal portion 110 can extend from a particular vertical drillhole portion 106.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A hazardous waste repository system, comprising:
at least one vertical access drillhole formed from a terranean surface into one or more subterranean formations, the at least one vertical access drillhole comprising an entry sized to receive a plurality of hazardous waste canisters that enclose hazardous waste into and through the at least one vertical access drillhole;
a first horizontal drillhole portion coupled to the at least one vertical access drillhole and sized to receive a first hazardous waste canister of the plurality of hazardous waste canisters, the first horizontal drillhole portion comprising a first hazardous waste repository area formed at a first depth within a storage subterranean formation; and
a second horizontal drillhole portion coupled to the at least one vertical access drillhole and sized to receive a second hazardous waste canister of the plurality of hazardous waste canisters, the second horizontal drillhole portion comprising a second hazardous waste repository area formed at a second depth within the storage subterranean formation such that a difference between the first and second depths is at least as much as a vertical drilling uncertainty, the second horizontal drillhole portion horizontally spaced apart from the first horizontal drillhole portion by a distance less than a horizontal drilling uncertainty.

2. The hazardous waste repository system of claim 1, further comprising:
a third horizontal drillhole portion coupled to the at least one vertical access drillhole and sized to receive a third hazardous waste canister of the plurality of hazardous waste canisters, the third horizontal drillhole portion comprising a third hazardous waste repository area formed at the first depth within the storage subterranean formation, the third horizontal drillhole portion horizontally spaced apart from the second horizontal drillhole portion by a distance less than the horizontal drilling uncertainty.

3. The hazardous waste repository system of claim 2, wherein the third horizontal drillhole portion is horizontally spaced apart from the first horizontal drillhole portion by a distance at least as much as the horizontal drilling uncertainty.

4. The hazardous waste repository system of claim 2, further comprising:
a fourth horizontal drillhole portion coupled to the at least one vertical access drillhole and sized to receive a fourth hazardous waste canister of the plurality of hazardous waste canisters, the fourth horizontal drillhole portion comprising a fourth hazardous waste repository area formed at the second depth within the storage subterranean formation, the fourth horizontal drillhole portion horizontally spaced apart from the third horizontal drillhole portion by a distance less than the horizontal drilling uncertainty.

5. The hazardous waste repository system of claim 4, further comprising:
a fifth horizontal drillhole portion coupled to the at least one vertical access drillhole and sized to receive a fifth hazardous waste canister of the plurality of hazardous waste canisters, the fifth horizontal drillhole portion comprising a fifth hazardous waste repository area formed at a third depth within the storage subterranean formation such that a difference between the second and third depths is at least as much as the vertical drilling uncertainty, the fifth horizontal drillhole portion horizontally spaced apart from the second horizontal drillhole portion by a distance less than the horizontal drilling uncertainty.

6. The hazardous waste repository system of claim 1, wherein the at least one vertical access drillhole comprises only one vertical access drillhole.

7. The hazardous waste repository system of claim 1, wherein the hazardous waste comprises radioactive waste.

8. The hazardous waste repository system of claim 7, wherein the radioactive waste comprises spent nuclear fuel or high level waste.

9. The hazardous waste repository system of claim 1, wherein the storage subterranean formation comprises shale.

10. The hazardous waste repository system of claim 1, wherein the vertical drilling uncertainty is 3 meters.

11. The hazardous waste repository system of claim 1, wherein the horizontal drilling uncertainty is 10 meters.

12. The hazardous waste repository system of claim 1, wherein the horizontal drilling uncertainty and the vertical drilling uncertainty form an uncertainty ellipsoid.

13. The hazardous waste repository system of claim 2, wherein the second horizontal drillhole portion is stacked over the first horizontal drillhole portion, and respective uncertainty ellipses of the first and second horizontal drillhole portions are non-intersecting, and optionally a vertical access drillhole coupled to the first horizontal drillhole portion is parallel to or crosses a vertical access drillhole coupled to the second horizontal drillhole portion.

14. A method for forming a hazardous waste repository system, comprising:
forming at least one vertical access drillhole from a terranean surface into one or more subterranean formations, the at least one vertical access drillhole comprising an entry sized to receive a plurality of hazardous waste canisters that enclose hazardous waste into and through the at least one vertical access drillhole;
forming a first horizontal drillhole portion coupled to the at least one vertical access drillhole and sized to receive a first hazardous waste canister of the plurality of hazardous waste canisters, the first horizontal drillhole portion comprising a first hazardous waste repository area formed at a first depth within a storage subterranean formation; and
forming a second horizontal drillhole portion coupled to the at least one vertical access drillhole and sized to receive a second hazardous waste canister of the plurality of hazardous waste canisters, the second horizontal drillhole portion comprising a second hazardous waste repository area formed at a second depth within the storage subterranean formation such that a difference between the first and second depths is at least as much as a vertical drilling uncertainty, the second horizontal drillhole portion horizontally spaced apart from the first horizontal drillhole portion by a distance less than a horizontal drilling uncertainty.

15. The method of claim 14, further comprising:
forming a third horizontal drillhole portion coupled to the at least one vertical access drillhole and sized to receive a third hazardous waste canister of the plurality of hazardous waste canisters, the third horizontal drillhole portion comprising a third hazardous waste repository area formed at the first depth within the storage subterranean formation, the third horizontal drillhole portion horizontally spaced apart from the second horizontal drillhole portion by a distance less than the horizontal drilling uncertainty.

16. The method of claim 15, wherein the third horizontal drillhole portion is horizontally spaced apart from the first horizontal drillhole portion by a distance at least as much as the horizontal drilling uncertainty.

17. The method of claim 15, further comprising:
forming a fourth horizontal drillhole portion coupled to the at least one vertical access drillhole and sized to receive a fourth hazardous waste canister of the plurality of hazardous waste canisters, the fourth horizontal drillhole portion comprising a fourth hazardous waste repository area formed at the second depth within the storage subterranean formation, the fourth horizontal drillhole portion horizontally spaced apart from the third horizontal drillhole portion by a distance less than the horizontal drilling uncertainty.

18. The method of claim 17, further comprising:
forming a fifth horizontal drillhole portion coupled to the at least one vertical access drillhole and sized to receive a fifth hazardous waste canister of the plurality of hazardous waste canisters, the fifth horizontal drillhole portion comprising a fifth hazardous waste repository area formed at a third depth within the storage subterranean formation such that a difference between the second and third depths is at least as much as the vertical drilling uncertainty, the fifth horizontal drillhole portion horizontally spaced apart from the second horizontal drillhole portion by a distance less than the horizontal drilling uncertainty.

19. The method of claim 14, wherein the at least one vertical access drillhole comprises only one vertical access drillhole.

20. The method of claim 14, wherein the hazardous waste comprises radioactive waste.

21. The method of claim 20, wherein the radioactive waste comprises spent nuclear fuel or high level waste.

22. The method of claim 14, wherein the storage subterranean formation comprises shale.

23. The method of claim 14, wherein the vertical drilling uncertainty is 3 meters.

24. The method of claim 14, wherein the horizontal drilling uncertainty is 10 meters.

25. The method of claim 14, wherein the horizontal drilling uncertainty and the vertical drilling uncertainty form an uncertainty ellipsoid.

26. The method of claim 14, further comprising:
moving the first hazardous waste canister from the terranean surface into the first hazardous waste repository area; and
moving the second hazardous waste canister from the terranean surface into the second hazardous waste repository area.
